(19) United States
(12) Patent Application Publication
(10) Pub. No.: US 2006/0192850 A1
(43) Pub. Date: Aug. 31, 2006

(54) Method of and system to set an output quality of a media frame

(75) Inventors: Wilhelmus Franciscus Johannes Verhaegh, Eindhoven (NL); Clemens Christiaan Wust, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/553,918

(22) PCT Filed: Apr. 22, 2004
(86) PCT No.: PCT/IB04/50479

§ 371 Date: Oct. 20, 2005

(51) Int. Cl. H04N 7/14

(52) U.S. Cl. 348/14.12

(57) ABSTRACT

The invention relates to a method and system (900) to set an output quality of a next media frame, comprising application means (902) conceived to provide the output quality of a plurality of output qualities of the next media frame; and control means (904) conceived to set the output quality of the next media frame based upon a self-learning control strategy that uses a processing time and an output quality of a previous media frame to determine the output quality of the next media frame.

The invention relates to a method of setting an output quality of a next media-frame; wherein the output quality is provided by a media processing application; and the media processing application is designed to provide a plurality of output qualities of the next media-frame.

The invention further relates to a system of setting an output quality of a next media-frame; comprising application means conceived to provide the output quality of a plurality of output qualities of the next media frame.

The invention further relates to a computer program product designed to perform such a method.

The invention further relates to a storage device comprising such a computer program product.

The invention further relates to a television set comprising such a system.

An embodiment of such a method and system is disclosed in WO2002/019095. Here, a method of running an algorithm and a scalable programmable processing device on a system like a VCR, a DVD-RW, a hard-disk or on an Internet link is described. The algorithms are designed to process media frames, for example video frames while providing a plurality of quality levels of the processing. Each quality level requires an amount of resources. Depending upon the different requirements for the different quality levels, budgets of the available resources are assigned to the algorithms in order to provide an acceptable output quality of the media frames. However, the content of a media stream varies over time, which leads to different resource requirements of the media processing algorithms over time. Since resources are finite, deadline misses are likely to occur. In order to alleviate this, the media algorithms can run in lower than default quality levels, leading to correspondingly lower resource demands.

It is an object of the invention to provide a method according to the opening paragraph that sets a quality of a media-frame in an improved way. In order to achieve this object, the method comprises setting the output quality of the next media frame based upon a self-leaning control strategy that uses a processing time and an output quality of a previous media-frame to determine the output quality of the next media-frame.

An embodiment of the method according to the invention is described in claim 2, wherein the method comprises: processing the previous media-frame; determine a state comprising of a relative progress value of the processed previous media-frame; a scaled budget value of the processed previous media-frame; and the output quality of the processed previous media-frame; determine a revenue based upon the state and a possible output quality of the next media-frame.

An embodiment of the method according to the invention is described in claim 3, wherein the revenue is based upon a number of deadlines that were missed, the output quality of the previous media-frame, and a quality change.

An embodiment of the method according to the invention is described in claim 4, wherein the revenue for a finite number of states is determined, the finite number of states being determined by a finite set of scaled budget values and a finite set of relative progress values.

An embodiment of the method according to the invention is described in claim 5, comprising
reducing the number of states for which the revenue is determined by reducing those states that only differ in the output quality of the processed previous media-frame.

It is an object of the invention to provide a system according to the opening paragraph that sets an output quality of a media-frame in an improved way. In order to achieve this object, the system comprises control means conceived to set the output quality of the next media frame based upon a self-learning control strategy that uses a processing time and an output quality of a previous media frame to determine the output quality of the next media frame.

Embodiments of the system according to the invention are described in claims 7 and 8.

These and other aspects of the invention will be apparent from and elucidated with reference to the embodiments described hereinafter as illustrated by the following Figures:

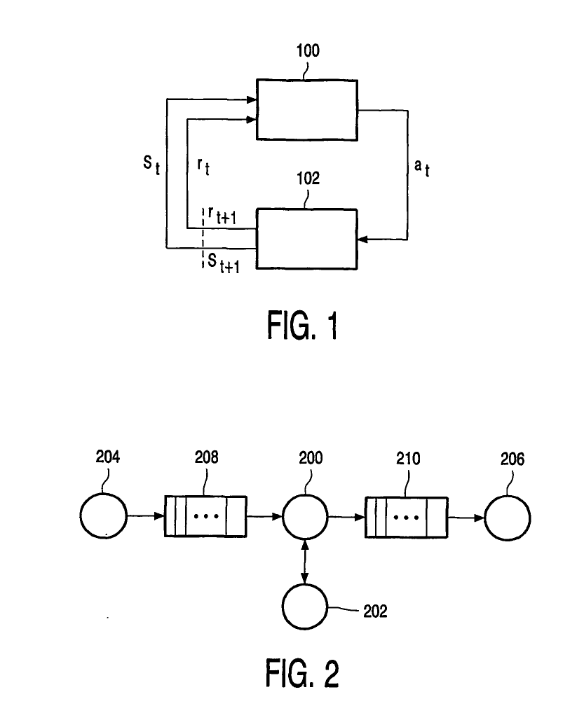

FIG. 1 illustrates an agent environment interaction in Reinforcement Learning;

FIG. 2 illustrates a basic scalable video processing task;

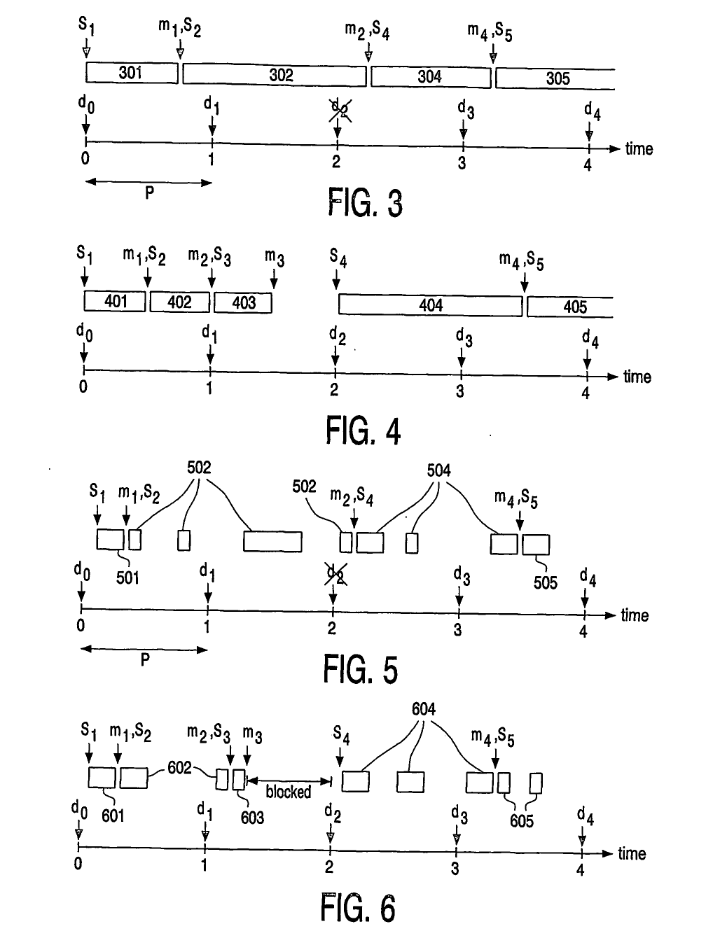

FIG. 3 illustrates the task's processing behavior by means of an example timeline;

FIG. 4 illustrates the task's processing behavior by means of a further example timeline;

FIG. 5 illustrates an example timeline for b=P/2;

FIG. 6 illustrates a further example timeline for b=P/2;

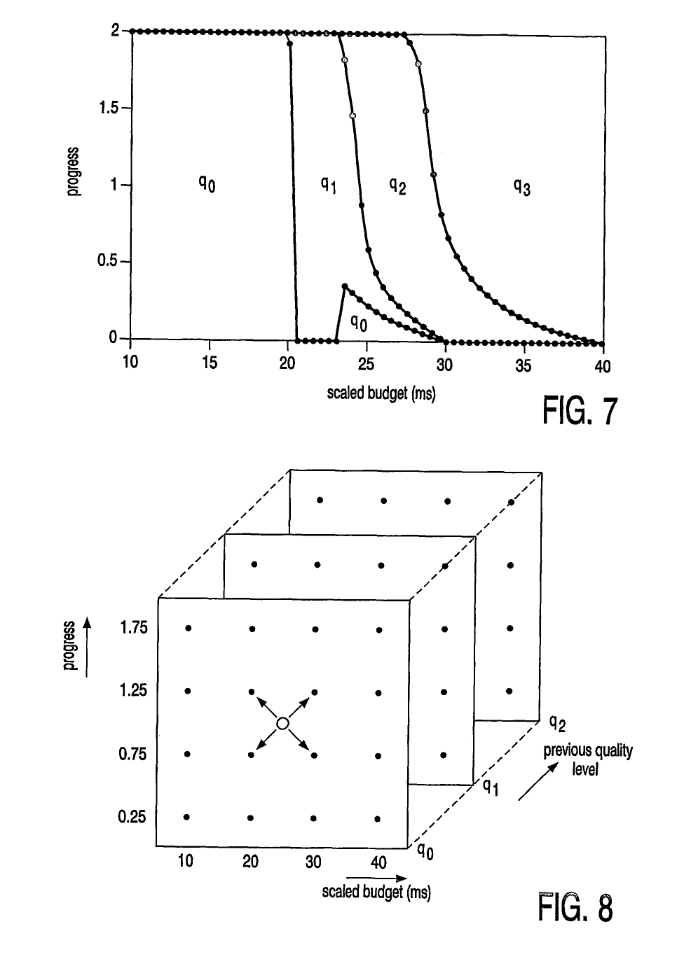

FIG. 7 shows a plane in the space of Markov policies;

FIG. 8 illustrates an example state space for three quality levels;

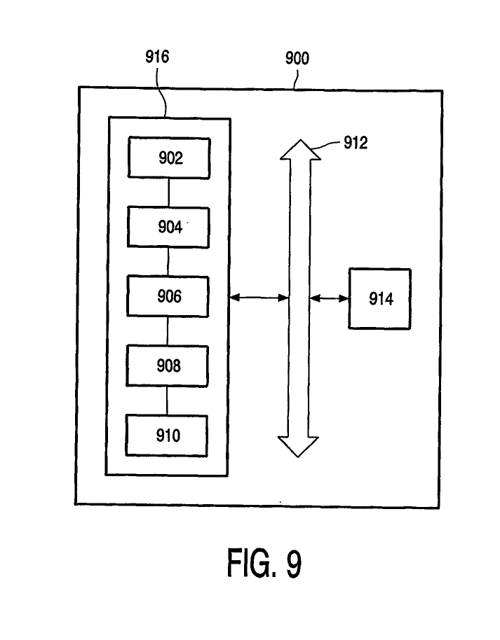

FIG. 9 illustrates the main parts of the system according to the invention in a schematic way.

FIG. 1 illustrates an agent environment interaction in Reinforcement Learning. Reinforcement Learning (RL) is a computational approach to goal-directed learning from interaction, see for example R. S. Sutton and A. G. Barto, Reinforcement Learning: an introduction, MIT Press, Cambridge, Mass. 1998. It is learning what to do—how to map states to actions—so as to maximize a numerical revenue signal. The learner and decision maker is called the agent. The thing it interacts with, comprising everything outside the agent, is called the environment. The agent is not told which actions to take, but must discover which actions yield the most revenue by trying them. An action may affect not only the imnmediate revenue but also the next situation and, through that, all subsequent revenues. These two characteristics—trial-and-error search and delayed revenue—are the two most important distinguishing features of RL.

RL is defined not by characterizing learning methods, but by characterizing a learning problem. Any method that is well suited to solving that problem is considered to be an RL method. One of the challenges in RL is the trade-off between exploration and exploitation. To obtain a lot of revenue, an RL agent must prefer actions that it has tried in the past and found to be effective in producing revenue. But to discover such actions, it has to try actions it has not selected before. The agent has to exploit what it already knows in order to obtain revenue, but it also has to explore in order to make better action selections in the future. The dilemma is that generally neither exploration nor exploitation can be pursued exclusively without failing at the task. The agent must try a variety of actions and progressively favor those that appear to be the best. On a stochastic task, each action must be tried many times to gain a reliable estimate of its expected revenue.

Apart from the agent and the environment, one can identify three main sub-elements of an RL system: a policy, a revenue function, and a value function. A policy defines the agent's way of behaving at a given time. A policy is a mapping from states of the environment to actions to be taken in those states. In general, policies may be stochastic. A revenue function defines the goal in an RL problem. It maps each perceived state (or state-action pair) of the environment to a single number, a revenue, indicating the intrinsic desirability of that state. An RL agent's sole objective is to maximize the total revenue it receives in the long run. Revenue functions may be stochastic. A value function specifies what is good in the long run. The value of a state is the total amount of revenue an agent can expect to accumulate over the future, starting from that state. Whereas revenues determine the immediate, intrinsic desirability of environmental states, values indicate the long-term desirability of states after taking into account the states that are likely to follow applying the policy, and the revenues available in those states. Values must be estimated and re-estimated from the sequences of observations an agent makes over its entire lifetime.

The agent 100 and the environment 102 interact continually, the agent 100 selecting actions and the environment 102 responding to those actions and presenting new situations to the agent. The environment 102 also gives rise to revenues, special numerical values that the agent 100 tries to maximize over time. The agent 100 and environment interact 102 at each of a sequence of discrete time steps, t=0,1,2,3, . . . . At each time step t, the agent 100 receives some representation of the environment's state, sₜ, ∈ S, where S is the set of environmental states, and on that basis selects an action, a₁ ∈ A (sₜ), where A (sₜ) is the set of actions available in state sₜ. One time step later, in part as a consequence of its action, the agent 100 receives a numerical revenue, rₜ₊₁∈ [symbol] , together with a new representation of the environmental state, sₜ₊₁.

At each time step t, the agent 100 implements a mapping from states to probabilities of selecting each possible action. This mapping is called the agent's policy and is denoted by πₜ, where πₜ (s,a) is the probability that aₜ=a if sₜ=s. A policy may also be deterministic, which means that each state is mapped to a single action. RL methods specify how the agent 100 changes its policy as a result of its experience. The agent's goal, roughly speaking, is to maximize the total amount of revenue it receives in the long run.

In RL, the goal of the agent 100 is formalized in terms of a special revenue signal passing from the environment 102 to the agent 100. At each time step t>0, the revenue is a simple number, rₜ∈ [symbol] Informally, the agent 100's goal is to maximize the total amount of revenue it receives. This means maximizing not the immediate revenue, but the cumulative revenue in the long run. If the agent 100 is expected to perform, revenues must be provided to it in such a way that in maximizing them the agent 100 will also achieve the goals. Therefore, the revenues must be set up such that they are in balance with the goal.

The agent's goal is to maximize the revenues it receives in the long run. In general, it is expected to maximize the expected return, where the return, Rₜ, is defined as some specific function of the revenue sequence. In the simplest case, the return is the sum of the revenues:
Rₜ=rₜ₊₁+rₜ₊₂+rₜ₊₃+ . . . +r_{T} (1)
where T is a final time step. This approach makes sense in applications where there is a natural notion of final time step, that is, when the agent-environment interaction breaks naturally into subsequences, which are called episodes, such as plays of a game, trips through a maze, or any sort of repeated interaction. Each episode ends in a special state called the terminal state, followed by a reset to a standard starting state or to a sample from a standard distribution of starting states. Tasks with episodes of this kind are called episodic tasks.

On the other hand, in many cases the agent-environment interaction does not break naturally into identifiable episodes, but goes on continually without limit. These are called continuing tasks. For continuing tasks the final time step would be T=∞, therefore the return, which is what is maximized, could itself be infinite. The additional concept that is needed is discounting. According to this approach, the agent 100 tries to select actions so that the sum of the discounted revenues it receives over the future is maximized. In particular, it chooses at to maximize the expected discounted return:

$${R}_{t} = {r}_{i + 1} + γ {r}_{i + 2} + {γ}^{2} {r}_{i + 3} + … = {\sum }_{k = 0}^{∞} {γ}^{k} {r}_{i + k + 1} , \qquad ( 2 )$$

where γ is a parameter, 0≦γ≦1, called the discount rate. The discount rate determines the present value of future revenues: a revenue received k time steps in the future is worth only γ^{k-1} times what it would be worth if it were received immediately. If γ<1, the infinite sum has a finite value as long as the revenue sequence {rₖ} is bounded. If γ=0, the agent 100 is ‘myopic’ in being concerned only with maximizing immediate revenues. As γ approaches 1, the objective takes future revenues into account more strongly: the agent 100 becomes more farsighted.

Most RL algorithms are based on estimating value functions—functions of states (or stateaction pairs) that estimate how good it is for the agent 100 to be in a given state (or how good it is to perform a given action in a given state). The notion of ‘how good’ is defined in terms of future revenues that can be expected, i.e. in terms of the expected return. The revenues the agent 100 can expect to receive in the future depend on what actions it will take. Accordingly, value functions are defined with respect to particular policies.

Recall that a policy, π, is a mapping from each state, s ∈ S, and action, a ∈ A (s), to the probability π(s, a) of taking action a when in state S. Informally, the value of a state s under a policy π, denoted by V^{π} (s), is the expected return when starting in state s and following π thereafter:

$${V}^{π} ( s ) = {E}_{π} \{ {R}_{t} \text{\vert} {s}_{t} = s \} = {E}_{π} \{ {\sum }_{k = 0}^{∞} {γ}^{k} {r}_{i + k + 1} \text{\vert} {s}_{t} = s \} . \qquad ( 3 )$$

Similarly, the value of taking action a in state s under a policy π, denoted Q^{π} (s;a), is defined as the expected return starting from s, taking action a, and thereafter following policy π:

$${Q}^{π} ( s ; a ) = {E}_{π} \{ {R}_{t} \vert {s}_{t} = s , {a}_{t} = a \} = {E}_{π} \{ {\sum }_{k = 0}^{∞} {γ}^{k} {r}_{i + k + 1} \text{\vert} {s}_{t} = s , {a}_{t} = a \} . \qquad ( 4 )$$

Q^{π} is called: the action-value function for policy π.

To select an action at a time step, given the state s, a method is to behave greedy, i.e. to select the action a for which Q(s; a) is maximal. This method exploits current knowledge to maximize immediate revenue, but it spends no time exploring apparently inferior actions to see if they might really be better. A simple alternative is to behave greedily most of the time, but every once in a while, say with a probability ε, instead select an action at random, uniformly, independently of the action-value estimates. Methods using this near-greedy action selection rule are called ε-greedy methods.

Sarsa is a Temporal Difference (TD) learning method. TD learning methods can learn directly from raw experience without a model of the environment's dynamics, and they update estimates of values based in part of other learned estimates of values, without waiting for a final outcome (they bootstrap). In Sarsa, the update rule for action-values is given by
Q(sₜ;aₜ)←Q(sₜ;aₜ)+α[rₜ₊₁+γ·Q(sₜ₊₁;aₜ₊₁)−Q(sₜ;aₜ)], (5)
where sₜ denotes the state at a time step t, aₜ denotes the action taken at time step t, rₜ₊₁ denotes the revenue received at the next time step, t+1, sₜ₊₁ denotes the state at the next time step, aₜ₊₁ denotes the corresponding action to be taken, and ← denotes the update of the left-hand value with the right-hand value. This update is done after every transition from a state st. This rule uses every element of the quintuple of events, (sₜ, aₜ, rₜ₊₁, sₜ₊₁, aₜ₊₁), that make up a transition from one state-action pair to the next. This quintuple gives rise to the name Sarsa for the algorithm.

Below a learning algorithm based on the Sarsa update rule is given, for a continuing task:

Algorithm SARSA

a. initialize all Q(s;a) arbitrarily
b. initialize s
c. select the action a for which Q(s;a) is maximal (ε-greedy)
d. repeat
e. take action a
f. at the next time step, observe the resulting revenue r′ and the new state s′
g. select the action a′ for which Q(s′;a′) is maximal (ε-greedy)
h. Q(s;a)←Q(s;a)+α·(r′+γ·Q(s′;a′)−Q(s;a))
i. s←s′,a←a′

Consumer terminals, such as set-top boxes and digital TV-sets, currently apply dedicated hardware components to process video. In the foreseeable future, programmable hardware with video processing in software is expected to take over. Some of the characteristics of this, so called software video processing are: highly fluctuating, data dependent, resource requirements.

With video processing there is usually a gap between the worst-case and average-case decoding times. Moreover, there is a distinction between short-term (or stochastic), and long-term (or structural) load fluctuations. Structural load fluctuations are, amongst others, caused by the varying complexity of video scenes. Since worst-case resource allocation is usually less acceptable, due to high pressure on cost, resource allocation preferably has to be closer to average case. To prevent overload, some form of load reduction is inevitable.

Soft timing requirements for tasks with fluctuating load such as acceptance of occasional deadline misses or an average-case response time requirement can be viewed as a special case of Quality of Service (QoS), ‘the collective effect of service performances that determine the degree of satisfaction by a user of the service’, see ITU-T Recommendation E.800-Geneva 1994. The QoS abstraction provides a means to reason about and deal with tasks with heterogeneous soft timing requirements and heterogenous adaptive capabilities, such as approximate computing, or job skipping within a single system.

Resource reservation, with temporal protection, allows to dissect the overload management problem for heterogenous soft-real time systems into a number of sub-problems that can be addressed separately. In this way, overload management and semantic (i.e. value-based) decision-making can be taken out of the scheduler. Two responsibilities remain to be addressed: deciding which task gets which budget, and adjusting the load of each task to its assigned budget. The first responsibility is global, and requires a unified QoS measure. The second responsibility is local, and may use task-specific QoS adaptation.

Here local QoS control is concerned, i.e. trying to optimize the local QoS within the allocated budget, in the context of high-quality video processing. It is assume that the video processing task is scalable, i.e. that it can trade picture quality for resource usage at the level of individual frames, and that the task works ahead, i.e. that it can start processing the next frame immediately after completing the previous one, provided that the data are available. These scalable video algorithms provide a limited number of QoS levels that can be chosen for each frame. The extent to which working ahead can be applied is determined by latency and buffer constraints. The QoS specification for high-quality video combines three elements, which have to be balanced: processing quality, deadline misses, and quality changes.

The balancing control strategies are concerned with two types of load fluctuations: short-term (or stochastic), and structural. To control the short-term load fluctuations, the control problem is modeled as a Markov Decision Process, which is a general approach for solving discrete stochastic decision problems, see Markov Decision Processes: discrete stochastic dynamic programming, Wiley Series in Probability and Mathematical Statistics, Wiley-Interscience, New York, 1994, M. L. Puterman. To deal with structural load fluctuations, budget scaling is used: applying the original static or dynamic solution for a budget that is inversely proportional to the current structural load.

FIG. 2 illustrates a basic scalable video processing task An single, asynchronous, scalable video processing task 200 is considered, with an associated controller 202. The video processing task 200 can process frames at a (possibly small) discrete number of quality levels. The video processing task 200 retrieves frames to be processed from an input queue 204, and places processed frames in an output queue 210. For convenience, it is assumed that the successive frames are numbered 1,2, . . . . An input process 204 (for example a digital video tuner) periodically inserts frames into the input queue, with a period P, and an output process 206 (for example a video renderer) consumes frames from the output queue, with the same period P. Hence, it is assumed that the input and output frame rates are the same, but they could be different too. The input process 204 and the output process 206 are synchronized with a fixed latency δ, i.e., if frame i enters the input queue 208 at time eᵢ=eₒ+i*P, where eₒ is an offset, then the frame is consumed from the output queue 210 at time eᵢ+δ. Before processing a frame, the controller 202 selects the quality level at which the frame is processed. The processing time for a frame depends on both the chosen quality level and the data complexity of the frame. On average, the task has to process one frame per period P. By choosing the latency δ larger than P, the task is given some space to even-out its varying load by working ahead.

Consider a frame i, which enters the input queue at time eᵢ. Clearly, eᵢ is the earliest start time for processing the frame, and dᵢ=eᵢ+δ is the latest possible completion time, thus the deadline. For convenience, a virtual deadline dₒ=eₒ+δ is defined. The actual start time for frame i, the i-th start point of the task, is denoted by sᵢ. The actual completion time for frame i, the i-th milestone of the task, is denoted by mᵢ. With a non-zero processing time for frames it holds that mᵢ>eᵢ. If mᵢ>dᵢ, the task has missed its deadline for frame i. If mᵢ₋₁<eᵢ, assuming i>1, the task is blocked from mᵢ₋₁ until eᵢ. For i>1, sₜ≧max{mᵢ₋₁, eᵢ}.

A work preserving approach is assumed, which means that a frame is not aborted if its deadline is missed, but is completed anyhow. Other approaches can be used too. The frame is then used for the next deadline. Note that, even additional deadlines of subsequent frames may be missed before the frame is completed. If a deadline is missed, the following actions are needed. First, the output process has to perform error concealment. For example, a video renderer could reuse the most recently displayed frame. Such an error concealment can reduce the perceived quality, especially in scenes with a lot of motion. Second, the controller performs error recovery by skipping a subsequent frame, to restore the correspondence between frame number and deadline and to avoid a pile-up in the input queue. The frame to be skipped should be chosen carefully. For example, in MPEG-decoding, B-frames can safely be skipped, whereas skipping an I-frame can stall the stream.

FIGS. 3 and 4 illustrate the task's processing behavior by means of two example timelines, in which P=1, δ=2, and s₁=d₀=0. The task has to process 5 frames. The frames actually processed are denoted in FIG. 3 by reference numerals 301, 302, 304, and 305 and in FIG. 4 by reference numerals 401, 402, 403, 404, and 405. In FIG. 3, deadline d₂ is missed. The controller handles the deadline miss by using frame 302 at deadline d₃ and by skipping frame 303. In FIG. 4, the task becomes blocked at milestone m₃, because frame 404 is not present in the input queue (e₄=d₂).

Starting at d₀, in the period between each pair of successive deadlines the task is assigned a guaranteed processing time budget b (0≦b≦P). Based on this guaranteed budget, a measure called progress is introduced. Progress ρ₁, calculated at a start point s₁, is the total amount of guaranteed budget left until dᵢ₋₁, divided by b. This progress indicates how much budget is left after completing the previous frame i-1. Progress is an important measure for the controller, because a larger progress leads to a lower risk of missing the deadline for the frame to be processed. Progress is always non-negative; in case of deadline misses, this is ensured by using the completed frame at a later deadline. Furthermore, due to limited queue sizes there is also an upper bound ρ^{max}=δ-1 on progress. Note that progress at a start point is computed based on the deadline of the just-completed frame. The reason not to compute progress at milestones is that budget losses due to blocking would otherwise not be accounted for in the progress. In case of blocking, the progress used by the controller at the first-next start point would then be too high (>p^{max}).

In FIGS. 3 and 4, it is assumed that b=P, which means that the task has a private processor. In FIG. 3, the progress at the successive start points is given by ρ₁=0, ρ₂=0.25, ρ₄=0.75, and ρ₅=0.75, respectively, and in FIG. 4 by ρ₁=0, ρ₂=0.5, ρ₃=1, ρ₄=1, and ρ₅=0.5, respectively.

FIGS. 5 and 6 illustrate two example timelines for b=P/2. The task has to process 5 frames. The frames actually processed are denoted in FIG. 5 by reference numerals 501, 502, 504, and 505 and in FIG. 6 by reference numerals 601, 602, 603, 604, and 605. Again, it is assumed that P=1, ρ=2, and d₀=0. It is further assumed that s₁ is the moment at which the task is assigned budget for the first time. In FIG. 5, the progress at the successive start points is given by ρ₁=0, ρ₂=0.5, ρ₄=0.75, and ρ₅=0.5, respectively, and in FIG. 6 by ρ₁=0, ρ₂=0.5, ρ₃=0.75, ρ₄=1, and ρ₅=0.5, respectively. Note that in each period the budget is distributed differently, as determined by an underlying scheduler. In FIG. 6, at m₃ the task has consumed half of its budget for that period. The other half of the budget is lost due to blocking.

As mentioned before, at each start point the controller has to select the quality level at which the upcoming frame is processed. Preferably, a control strategy is chosen that finds an optimal balance to meet the following three objectives:
because deadline misses and the accompanying frame skips result in artifacts in the output, deadline misses should be as sparse as possible. To prevent deadline misses, it may be necessary to process frames at lower quality levels.
to obtain a high output quality, frames should be processed at an as high as possible quality level.
the number and size of quality-level changes should be as low as possible, because (bigger) changes in the quality level may result in (better) perceivable artifacts.

To find an optimal balance, a numerical revenue is assigned to each frame that is processed. A revenue is composed of a (possibly high) penalty on the number of deadlines missed while the frame is being processed, a reward for processing the frame at a particular quality level, and a penalty for processing the frame at a quality level that differs from the one used for the preceding frame. Any control strategy that maximizes the average revenue over a sequence of frames balances the three objectives. Moreover, the average revenue provides a tunable QoS metric for the task.

If, for each quality level, the processing time for each frame is known in advance, finding a control strategy that maximizes the average revenue can be computed. In that case, the optimal quality levels can be computed off-line using dynamic programming, see Dynamic Programming, Princeton University Press, Princeton, N.J., 1957 R. E. Bellman.

As a first step towards a run-time control strategy, the system is modeled as a Markov Decision Process (MDP). An MDP considers a set of states, and a set of actions for each state. At discrete moments in time, the control points, a controller observes the current state s of the system, and subsequently takes an action a. This action influences the system, and, as a result, the controller observes a new state s′ at the next discrete moment. This new state is not deterministically determined by the action and the previous state, but each combination (s,a,s′) has a fixed known probability. A numerical revenue is associated with each state transition (s,s′). The goal of the MDP is to find a decision strategy that maximizes the average revenue over all state transitions during the lifetime of the system.

Here, the discrete moments at which the controller observes the system are the start points sᵢ. The state includes the task's progress at that start point, ρᵢ. Because quality-level changes are penalized, the state also includes the quality level used for the preceding frame (the previous quality level qᵢ₋₁). Hence, sᵢ=(ρᵢ,qᵢ₋₁). Finally, an action is the selection of a quality level qᵢ, and the revenues for each state change are defined according to the description above.

With a first strategy, referred to as MDP strategy, solve the MDP is solved off-line. This implies that the state transition probabilities Pr(s,a,s′) are needed in advance. Therefore, the per-frame processing times are measured for a number of representative video sequences, at different quality levels, and these sequences are used to compute the state transition probabilities. The MDP is then solved off-line for a particular value of the budget b. This results in a (static) Markov policy, which is a set of state-action pairs, here: (ρᵢ,qₜ₋₁;qᵢ). During run time, at each start point, the controller decides its action by consulting the static Markov policy, a simple table look-up.

The MDP can also be solved at run-time, by means of Reinforcement Learning (RL), as previously described. An RL control strategy starts with no knowledge at all, and learns optimal behavior from the experience it gains during run time. The state-action values are applied to choose the quality level at start points. Given the state, the quality level (=action) yielding the largest state-action value is chosen. This approach is referred to as the RL control strategy.

As previously described there are short-term and structural load fluctuations. Sharp transitions between structural load values are quite exceptional. In general, the transitions are much more smooth.

The MDP and RL control strategies implicitly assume that the processing times of successive frames are mutually independent. This is roughly the case for short-term load fluctuations, but not for structural load fluctuations. In order to deal with the structural load fluctuations too, the following enhancements can be applied to the MDP and RL strategies:
tracking the structural load during run time, by filtering out the short-term load fluctuations, and comparing it to a reference budget
compensating the original MDP and RL strategies for structural load fluctuations relative to this reference budget, not by adjusting the allocated budget, but by applying the policy derived for an inversely proportional budget, also called: the scaled budget.
   These enhanced strategies are denoted by MDP* and RL*, respectively.

To track the structural load at a start point, the ratio between the actual processing time apt of the just-completed frame and the expected processing time ept for a frame at the applied quality level, i.e. cf=apt/ept must be determined. The expected processing times have been derived off-line for each quality level. This ratio is referred to as a complication factor cf

It is assumed that the complication factor for a frame is more or less independent of the applied quality level: if the frame is processed at a different quality level, it should give roughly the same complication factor. This assumption is needed because the processing time for the quality level at which the completed frame has been processed can be measured, which is not necessarily the quality level selected for subsequent frames.

The complication factors follow the shortterm and the structural load fluctuations. To obtain a more proper measure for the structural load, the short-term load fluctuations are preferably filtered out, to obtain a running complication factor rcf. Several types of filters are suitable for this purpose, such as FIR, IIR, and median filters, see Digital Signal Processing, Prentice-Hall, Englewood Cliffs, N.J., 1975, A. V. Oppenheim and R. W. Schafer. Applying an IIR filter. For example an exponential, recency-weighted-average with a step-size parameter of 0.05 can be used.

The running complication factor rcf is the basis for the scaled budget. If rcf deviates from one, it appears as if the processing budget available to the task deviates from its available budget b. If rcf=1.2, a budget b=30 ms would appear as a budget of only 25 ms. If rcf=0.8, that same budget would appear as a budget of 37.5 ms. Therefore, a scaled budget is defined as b/rcf. During run time, the scaled budget is computed at each start point.

The MDP* strategy enhances the MDP strategy in the following way. First, the statistics needed for solving the MDP are normalized, which means that the structural load fluctuations are filtered out. In this way the short-term load fluctuations is separated from the structural ones. In the off-line phase, the MDP is solved for a set of selected scaled budgets, resulting in a set of Markov policies, one for each scaled budget in the set. Next, during run-time, the new quality level at a start point is taken from the policy that corresponds to the actual value of the scaled budget If the required policy is not in the set, the desired value is obtained by linear interpolation in the space of Markov policies.

FIG. 7 shows a plane in the space of Markov policies, for one particular previous quality level q₂. In this plane, a vertical line at scaled budget value 28.2 ms corresponds to the q₂ column in the Markov policy for scaled budget 28.2 ms, which is obtained by interpolation from the policies for scaled budgets 28.0 ms and 28.5 ms.

In the RL* approach the scaled budget is directly added to the state, i.e., the scaled budget becomes a third dimension of the state space. At a start point, given the state (=scaled budget, progress, previous quality level), the quality level (=action) yielding the largest state-action value is preferably chosen.

Within the RL* approach, the agent 100 as previously described with reference to FIG. 1, is a controller, selecting the quality level at which frames are processed. The environment 102 is given by the scalable video processing task. The discrete time steps at which the agent interacts with its environment are the start points. The tasks state at a start point is defined by the combination of the scaled budget (sb), the progress (p), and the previous quality level (pq). An action is the choice of a quality level q at which a frame is processed. For states s=(sb, p, pq) and actions q, the agent 100 keeps track of action-values Q(s; q).

After processing a frame, at the start point of the subsequent frame to be processed, the agent first updates the scaled budget using the processing time of the just-completed frame. This updated scaled budget is part of the state at the start point. Next, the agent computes the revenue for the just-completed frame. For notational convenience, it is assumed that the just-completed frame was processed at quality level q and that the frame before that was processed at quality level pq. The revenue is composed of a (high) negatively-valued penalty on the number of deadlines that were missed since the previous start point, a positively-valued reward for the quality level q at which the frame was processed, and a negatively-valued quality-change penalty qcp(pq, q) for changing the quality level from pq to q. Note that the agent computes the revenue based on information provided by the environment (number of deadline misses, quality levels), instead of receiving the revenue directly from the environment. Using the revenue, the agent updates (learns) its action-values. After that, the updated action-values are used to select the quality level for the next frame to be processed, i.e. the frame that corresponds to the start point.

Within the computations needed, a finite number of states can be considered, while both the scaled budget and the progress are continuous variables. To address this a finite set of scaled budget values \overline{SB}={sb₁, . . . ,sbₙ} and a finite set of progress values \overline{R}={{ρ₁, . . . , ρₘ}. are defined. Then only for gridpoint states s, i.e. states s=(sb, ρ, pq) for which sb∈ \overline{SB} and p ∈ \overline{R}, track of action-values Q(s;q) must be kept. To approximate the action-value for a non-gridpoint state, linear interpolation on the action-values of the surrounding gridpoint states is applied.

FIG. 8 illustrates an example state space for three quality levels, q₀ to q₂. In this state space, the scaled budget points are 10 ms, 20 ms, 30 ms, and 40 ms, and progress points are 0.25, 0.75, 1.25, and 1.75. To approximate the action-value for a state with a scaled budget of 25 ms, a progress of 1, and a previous quality level q₀, linear interpolation is applied on the action-values of the four surrounding gridpoint states, as indicated in the FIG. 8.

In each iteration of the Sarsa algorithm, normally one action-value is learned (updated). As a result, learning can take a long time, and there can be a need for exploring actions (which is often not optimal). With the current invention, in each iteration (at each start point) the action values for all grid point states are updated, which learns faster. Moreover, there is no longer a need for exploring actions, which means that what has been learned can be exploited better. At a start point, the processing time of the just-completed frame, pt is determined. This frame was processed at a particular quality level, q. To estimate the processing time for the frame at a different quality level, the off-line determined ept-values (expected processing time) are used that were also used for budget scaling. For example, if a frame, processed at quality level q₂_l , yields a processing time of 20 ms, and if ept (q₀)=15 ms and ept (q₂)=22 ms, then the estimated processing time for the frame at quality level q₀ is 20 ms·ept(q₀)/ept(q₂)=13.6 ms. The estimated processing times are used to simulate processing the frame. Starting at a grid point state sₜ, and taking a particular quality-level action qᵢ, using the estimated processing time for quality level qᵢ the resulting (non-grid point) state sᵢ₊₁ after processing the frame, the corresponding greedy quality-level action qₜ₊₁, and the resulting revenue rᵢ₊₁. can be computed. In this computation, first the processing time for budget scaling (normalization step) is corrected. Using this information, the Sarsa update rule is applied. At each start point this is done preferably for all grid point states and all quality-level actions. Consequently, there is preferably no need to take a random (non-greedy) action every now and then. The invention can be implemented by the following algorithms, wherein: sbp denotes the point wherein the scaled budget is calculated, i.e. the scaled budget point; rpp denotes the point wherein the relative progress is calculated, i.e. the relative progress point; and pq denotes the previous quality.

Algorithm Initialize

1a. initialize the running complication factor
   rcf←1
1b. for all states (shp, rpp, pq)
1c. for all quality actions q
1d. initialize the (state,action)-value
   Q(sbp,rp,pq;q)←0
   Algorithm Get Decision Quality
Input: relative progress rp
Input: previously used quality pq
Output: decision quality dq
2a compute the scaled budget
   sb←b/rcf
2b for scaled budget sb, relative progress rp, and previous quality pq, compute the interpolated (state,action)-values Q_{ivec} (sb,rp,pq;q) for all possible quality actions q
2c. decision quality dq is the quality action q that corresponds to the highest value Q_{ivec} (sb, rp,pq;q)
   Algorithm Update (State,Action)-Values
Input: processing time pt
Input: processing quality q
3a. make a copy of the running complication factor corresponding to the situation that existed before processing the last unit of work
   oldrcf←rcf
3b. usept and q to update the running complication factor

$$rcf ← rcf + α \cdot ( \frac{pt}{avg ( q )} - rcf )$$
3c. compute the scaled budget
   sb←b/rcf
3d. for all states (sbp,rpp,pq)
3e. for all quality actions \tilde{q}
3f. estimate the processing time of the last unit of work for quality \tilde{q}

$$ept ← \frac{avg ( \tilde{q} )}{avg ( q )} pt$$
3g. simulate processing the last unit of work in quality \tilde{q}, starting in state (sbp, rpp, pq), and having a normalized processing time ept/oldrcf
3h. observe both the resulting revenue rev and the resulting relative progress rp
3i. for scaled budget sb (derived in 3c), relative progress rp, and previous quality \tilde{q}, compute the interpolated (state,action)-values Q_{ivec} (sb,rp, \tilde{q}; \tilde{q}′) for all possible quality actions \tilde{q}′
3j. Q′ is the highest value Q_{ivec} (sb, rp, \tilde{q}; \tilde{q}′)
3k. update the (state.action)-value Q(sbp, rpp,pq; \tilde{q}) using rev and Q′
   Q(sbp, rpp,pq; \tilde{q})=Q(sbp, rpp,pq; \tilde{q})+β.(rev+γ Q′−Q(sbp, rpp,pq; \tilde{q}))

To reduce the number of states in computations, the following technique may be applied. Let sₓ=(sb, ρ, pqₓ) and s_{y}=(sb, ρ,pq_{y}) be gridpoint states that only differ in the previous quality level, pqₓ and pq_{y} respectively. The processing time for a frame is independent of the quality level applied for the preceding frame. Therefore, at a start point, if quality level q is chosen in either state sₓ or s_{y}, the resulting state at the next start point is the same. In terms of action-values, this means that Q(sₓ;q)−qcp(pqₓ, q)=Q(s_{y}; q)−qcp(pq_{y}, q). This observation can be used as follows to reduce the number of states in computations. To learn action-values two-dimensional gridpoint states are used, i.e., all combinations of a scaled budget from set SB and a progress from set \overline{R}. To obtain the action-value Q′((sb, ρ, pq); q) for choosing quality level q in a 3 -dimensional gridpoint state (sb, ρ, pq), a penalty qcp(pq;q) to the learned action-value Q′((sb, ρ); q) is added. In other words, Q((sb, ρ, pq);q)=Q′((sb, p);q)+qcp(pq,q), and action-value Q′ is learned. In this way, the number of states to be updated is reduced by a factor |Q|, where Q is the set of quality levels.

The order in the described embodiments of the method of the current invention is not mandatory, a person skilled in the art may change the order of steps or perform steps concurrently using threading models, multi-processor systems or multiple processes without departing from the concept as intended by the current invention.

FIG. 9 illustrates the main parts of the system according to the invention in a schematic way. The system 900 comprises a microprocessor 914, a software bus 912 and a memory 916. The memory 916 can be a random access memory (RAM). The memory 916 communicates with the microprocessor 914 through software bus 912. The memory 916 comprises computer readable code 902, 904, 906, 908, 910, and 912. The computer readable code 902 is designed to provide the output quality of a plurality of output qualities of the next media frame. The computer readable code 904 is designed to set the output quality of the next media frame based upon a self-learning control strategy that uses a processing time and an output quality of a previous media frame to determine the output quality of the next media frame. The computer readable code 906 is designed to process the previous media-frame. The computer readable code 908 is designed to determine a state comprising of a relative progress value of the processed previous media-frame; a scaled budget value of the processed previous media-frame; and the output quality of the processed previous media-frame. The computer readable code 910 is designed to determine a revenue based upon the state and a possible output quality of the next media-frame. The computer readable code 912 is designed to reduce the number of states for which the revenue is determined by reducing those states that only differ in the output quality of the processed previous media-frame. The system can be comprised within a television set. Furthermore, the computer readable code can be read from a computer readable medium such as a CD or DVD.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. Method of setting an output quality of a next media-frame, wherein
the output quality is provided by a media processing application;
the media processing application is designed to provide a plurality of output qualities of the next media-frame; and
setting the output quality of the next media frame is based upon a self-learning control strategy that uses a processing time and an output quality of a previous media-frame to determine the output quality of the next media-frame.

2. Method according to claim 1, the method comprising:
processing the previous media-frame;
determine a state comprising of
a relative progress value of the processed previous media-frame;
a scaled budget value of the processed previous media-frame; and
the output quality of the processed previous media-frame;
determine a revenue based upon the state and a possible output quality of the next media-frame.

3. Method according to claim 2, wherein the revenue is based upon a number of deadlines that were missed, the output quality of the previous media-frame, and a quality change.

4. Method according to claim 2, wherein the revenue for a finite number of states is determined, the finite number of states being determined by a finite set of scaled budget values and a finite set of relative progress values.

5. Method according to claim 2, comprising:
reducing the number of states for which the revenue is determined by reducing those states that only differ in the output quality of the processed previous media-frame.

6. System (900) to set an output quality of a next media frame, comprising:
application means (902) conceived to provide the output quality of a plurality of output qualities of the next media frame; and
control means (904) conceived to set the output quality of the next media frame based upon a self-learning control strategy that uses a processing time and an output quality of a previous media frame to determine the output quality of the next media frame.

7. System according to claim 6, the system comprising:
processing means (906) for processing the previous media-frame;
determining means (908) for determining a state comprising of
a relative progress value of the processed previous media-frame;
a scaled budget value of the processed previous media-frame; and
the output quality of the processed previous media-frame;
revenue means (910) for determining a revenue based upon the state and a possible output quality of the next media-frame.

8. System according to claim 7, the system comprising:
reduction means (912) for reducing the number of states for which the revenue is determined by reducing those states that only differ in the output quality of the processed previous media-frame.

9. A computer program product designed to perform the method according to claims 1.

10. A storage device comprising a computer program product according to claim 9.

11. A television set comprising a system according claim 6.
